(19) United States
(12) Patent Application Publication
(10) Pub. No.: US 2026/0301436 A1
(43) Pub. Date: Oct. 1, 2026

(54) METHOD AND SYSTEM FOR FINE IDENTIFICATION OF TYPES OF ANCIENT COINS BASED ON ARTIFICIAL INTELLIGENCE (AI) ARCHITECTURE OPTIMIZATION

(71) Applicant: Hangzhou Weipaitang Cultural Creative Co. Ltd, Hangzhou (CN)

(72) Inventors: Dashun CHENG, Hangzhou (CN); Xiuyun HU, Hangzhou (CN); Zewen XU, Hangzhou (CN); Zhiqiang TAN, Hangzhou (CN)

(73) Assignee: Hangzhou Weipaitang Cultural Creative Co. Ltd, Hangzhou (CN)

(21) Appl. No.: 19/561,666

(22) Filed: Mar. 10, 2026

(30) Foreign Application Priority Data
Mar. 31, 2025 (CN) 202510387195.8

(51) Int. Cl. G06V 20/66; G06T 5/50; G06T 5/70; G06T 7/11; G06V 10/74; G06V 10/77

(52) U.S. Cl. CPC G06V 20/66; G06T 5/50; G06T 5/70; G06T 7/11; G06V 10/761; G06V 10/7715; G06T 2207/10036; G06T 2207/20076; G06T 2207/20081; G06T 2207/20182; G06T 2207/20192

(57) ABSTRACT

A method for fine identification of types of ancient coins based on artificial intelligence (AI) architecture optimization includes: acquiring, by a multispectral imaging device, original ancient coin image data; performing illumination equalization processing and noise filtering to generate a standardized initial image; performing enhancement processing including texture enhancement to obtain a target image; invoking a pre-trained target ancient coin identification model to identify an ancient coin type, and obtaining a type identifier; and performing retrieval from a historical ancient coin database according to the identifier, outputting relevant data, and generating a fine identification report. In this way, fine identification of types of ancient coins is achieved, thereby improving the accuracy and efficiency of identification.

### CROSS REFERENCE TO THE RELATED APPLICATIONS

This application is based upon and claims priority to Chinese Patent Application No. 202510387195.8, filed on Mar. 31, 2025, the entire contents of which are incorporated herein by reference.

### TECHNICAL FIELD

The present disclosure relates to the technical field of artificial intelligence (AI), and in particular to a method and system for fine identification of types of ancient coins based on AI architecture optimization.

### BACKGROUND

Traditional ancient coin identification mainly relies on the experience and professional knowledge of experts, but this method has problems such as low efficiency and strong subjectivity, and expert resources are limited, making it hard to meet the demand for identification of a large number of ancient coins. With the development of AI technology, the use of image identification technology for ancient coin type identification has become a research hotspot. However, existing methods face problems such as uneven illumination, noise interference, and difficulty in capturing texture details when processing ancient coin images, thereby leading to low identification accuracy and failure to achieve fine identification of types of ancient coins. Therefore, there is an urgent need for a method for fine identification of types of ancient coins based on AI architecture optimization to improve the accuracy and efficiency of ancient coin identification.

### SUMMARY

An objective of the present disclosure is to provide a method and system for fine identification of types of ancient coins based on AI architecture optimization.

In a first aspect, an embodiment of the present disclosure provides a method for fine identification of types of ancient coins based on AI architecture optimization, including:
acquiring, by a multispectral imaging device, original ancient coin image data, performing illumination equalization processing and noise filtering on the original ancient coin image data, and generating a standardized initial ancient coin image;
performing enhancement processing on the initial ancient coin image, and generating a target ancient coin image, where the enhancement processing includes texture enhancement processing based on an edge-preserving algorithm;
invoking a pre-trained target ancient coin identification model to perform ancient coin type identification on the target ancient coin image, and obtaining an ancient coin type identifier of the target ancient coin image; and
triggering directional retrieval from a preset historical ancient coin database based on the ancient coin type identifier, outputting ancient coin-related data corresponding to the ancient coin type identifier, and generating a fine identification report of an ancient coin type based on the ancient coin-related data.

In a second aspect, an embodiment of the present disclosure provides a server system, including a server, where the server is configured to implement the method in the first aspect.

Compared with the prior art, the method for fine identification of types of ancient coins based on AI architecture optimization and system provided by the present disclosure have the following beneficial effects. First, original ancient coin image data is acquired by a multispectral imaging device, a standardized initial image is generated through illumination equalization processing and noise filtering, and enhancement processing including texture enhancement is performed to obtain a target image. Then, a pre-trained target ancient coin identification model is invoked to identify the ancient coin type, and a type identifier is obtained. Finally, retrieval from a historical ancient coin database is performed according to the identifier, relevant data is output, and a fine identification report is generated. In this way, fine identification of types of ancient coins is achieved, thereby improving the accuracy and efficiency of identification.

### BRIEF DESCRIPTION OF THE DRAWINGS

In order to more clearly illustrate the technical solutions in the embodiments of the present disclosure, a brief introduction to the drawings required for the embodiments will be provided below. It should be understood that the drawings below only show some embodiments of the present disclosure, and therefore should not be regarded as limiting the scope of the present disclosure. Those of ordinary skill in the art may obtain other relevant drawings based on these drawings without creative efforts.

FIG. 1 is a schematic flowchart of a method for fine identification of types of ancient coins based on AI architecture optimization according to an embodiment of the present disclosure; and

FIG. 2 is a schematic block diagram of a computer device according to an embodiment of the present disclosure.

### DETAILED DESCRIPTION OF THE EMBODIMENTS

To make the objectives, technical solutions, and advantages of the embodiments of the present disclosure clearer, the technical solutions in the embodiments of the present disclosure are clearly and completely described below with reference to the drawings in the embodiments of the present disclosure. Apparently, the described embodiments are merely some rather than all of the embodiments of the present disclosure. Generally, components of the embodiments of the present disclosure described and shown in the drawings may be arranged and designed in various manners.

The specific implementations of the present disclosure will be described in detail below with reference to the drawings.

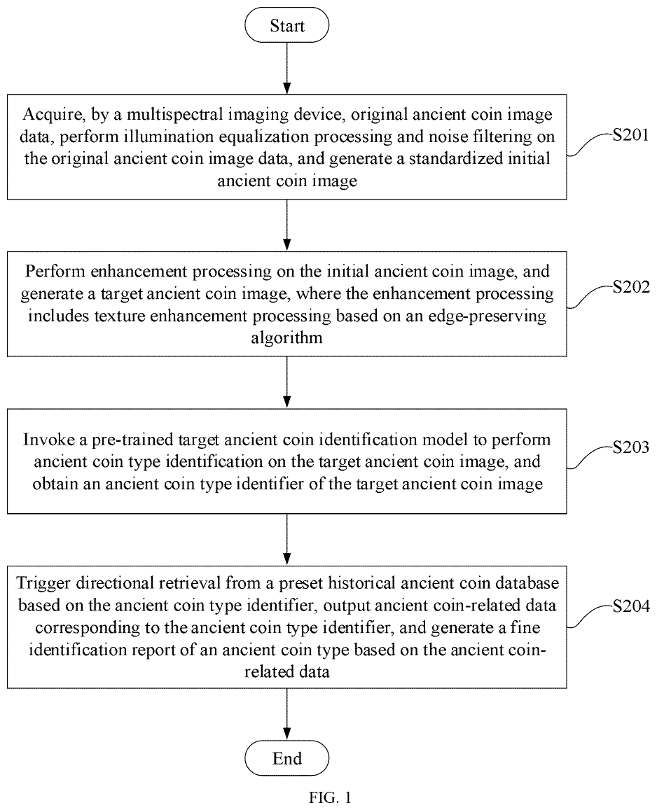

FIG. 1 is a schematic flowchart of a method for fine identification of types of ancient coins based on AI architecture optimization provided by an embodiment of the present disclosure to solve the technical problems in the aforementioned background art. The method for fine identification of types of ancient coins based on AI architecture optimization is described in detail below.

S201. Original ancient coin image data is acquired by a multispectral imaging device, illumination equalization processing and noise filtering are performed on the original ancient coin image data, and a standardized initial ancient coin image is generated.

S202. Enhancement processing is performed on the initial ancient coin image, and a target ancient coin image is generated, where the enhancement processing includes texture enhancement processing based on an edge-preserving algorithm.

S203. A pre-trained target ancient coin identification model is invoked to perform ancient coin type identification on the target ancient coin image, and an ancient coin type identifier of the target ancient coin image is obtained.

S204. Directional retrieval from a preset historical ancient coin database is performed based on the ancient coin type identifier, ancient coin-related data corresponding to the ancient coin type identifier is output, and a fine identification report of ancient coin types is generated based on the ancient coin-related data.

In an embodiment of the present disclosure, illustratively, a server controls the multispectral imaging device to acquire images of ancient coins. For example, in an ancient coin identification laboratory, an operator places an ancient coin to be identified in an imaging area of the multispectral imaging device. The server sends an instruction to the multispectral imaging device, and the device shoots the ancient coin from a plurality of spectral bands according to a preset parameter, thereby acquiring original ancient coin image data. The image data may exhibit uneven illumination and noise interference. For illumination equalization processing, the server analyzes the brightness value of each pixel in the original ancient coin image data. For example, if the left part of the ancient coin image is brighter and the right part is darker, the server adjusts the brightness distribution of the image by using algorithms such as histogram equalization. It counts the number of pixels at each brightness level in the image, and then redistributes the brightness values according to the statistical results to make the overall brightness of the image more uniform, just like adding a uniform “lighting” effect to the ancient coin image. In terms of noise filtering, the server uses algorithms such as median filtering or Gaussian filtering. For example, when there is salt-and-pepper noise (some randomly appearing black and white pixels) in the image, the server adopts a median filtering algorithm. For each pixel, it selects the pixel values of the pixel and its neighboring pixels, then sorts these values, and takes a median value as the new value of the pixel, thereby removing noise and making the image clearer. After illumination equalization processing and noise filtering, the server generates a standardized initial ancient coin image with uniform brightness and less noise, which is more conducive to subsequent processing. The server performs enhancement processing on the generated initial ancient coin image, including texture enhancement processing based on an edge-preserving algorithm. Taking an ancient coin with complex patterns as an example, the server identifies edge information in the ancient coin image, such as the outlines of characters and patterns on the ancient coin. It adopts edge-preserving algorithms such as bilateral filtering to smooth the image while preserving edge information. Bilateral filtering considers the spatial distance between pixels and the similarity of pixel values, performs smoothing processing on pixels that are close in distance and similar in pixel values, and retains the original values of pixels with large differences in pixel values at edges. In terms of texture enhancement, the server enhances the texture details in the ancient coin image. For example, some subtle patterns on the ancient coin may not be very obvious in the initial image, and the server sharpens the image by using algorithms such as the Laplacian operator. The Laplacian operator calculates the second derivative of each pixel in the image, enhances areas with large grayscale changes in the image, thereby highlighting the texture details of the ancient coin and making the characters and patterns on the ancient coin more clearly distinguishable. After such enhancement processing, the server generates a target ancient coin image with clearer texture and more obvious features. The server invokes a pre-trained target ancient coin identification model to process the target ancient coin image. This target ancient coin identification model is trained with a large amount of ancient coin image data. For example, during the training phase, the model learns the features of various types of ancient coins, such as shape, size, characters, and patterns. When the server inputs the target ancient coin image into the target ancient coin identification model, the model performs feature extraction and analysis on the image. It identifies the shape of the ancient coin to determine whether it is round, square or in other special shapes, analyzes the characters on the ancient coin to determine the font and content of the characters, and observes the patterns on the ancient coin, such as dragons, phoenixes, and flowers. Based on these features, the model matches them with the ancient coin types it has learned. Assuming that the target ancient coin image is a round ancient coin with a square hole, with the characters “Kaiyuan Tongbao” on it, then during the analysis process, the model compares these features with the features of various ancient coin types in its knowledge base, and finally determines that the type of the ancient coin is Kaiyuan Tongbao of the Tang Dynasty, and outputs a corresponding ancient coin type identifier, such as “T001” (assuming this is the identifier for Kaiyuan Tongbao). According to the obtained ancient coin type identifier “T001”, the server triggers directional retrieval from a preset historical ancient coin database. The historical ancient coin database stores a large amount of relevant data of different types of ancient coins, including historical background, casting technology, market value, rarity, and other information of ancient coins. The server searches for ancient coin-related data corresponding to “T001” in the database. For example, it finds the historical information of Kaiyuan Tongbao. For example, Kaiyuan Tongbao was first cast in the fourth year of Wude of Emperor Gaozu of the Tang Dynasty and was the main circulating currency of the Tang Dynasty. In terms of casting technology, it adopted the piece-mold casting method. The market value varies according to factors such as the appearance and rarity of the ancient coin. In terms of rarity, ordinary Kaiyuan Tongbao is relatively common, but some special editions of Kaiyuan Tongbao are relatively rare. The server sorts out and analyzes the retrieved ancient coin-related data, and generates a fine identification report of ancient coin types based on these data. The report includes basic information of the ancient coin, such as type and age, detailed introduction of historical background and casting technology, evaluation of the market value of the ancient coin, and explanation of rarity. Finally, the server outputs the generated fine identification report of ancient coin types, providing comprehensive and detailed ancient coin information for ancient coin identification personnel or relevant researchers.

In an embodiment of the present disclosure, the target ancient coin identification model is trained as follows.

An ancient coin identification model and a sample ancient coin image are acquired, where ancient coin training images of the sample ancient coin image include a first ancient coin training image and second ancient coin training images; and the first ancient coin training image is labeled with a corresponding ancient coin type identifier, and the second ancient coin training images are unlabeled ancient coin training images.

For each of the ancient coin training images, region division processing is performed on the ancient coin training image, and a plurality of ancient coin sub-images of the ancient coin training image are acquired.

Feature extraction processing is performed by the ancient coin identification model on the ancient coin training image and each of the ancient coin sub-images of the ancient coin training image, and a coarse-grained image feature of the ancient coin training image and a fine-grained image feature of each of the ancient coin sub-images are obtained.

Contrastive learning is performed on the coarse-grained image feature of each of the ancient coin training images of the sample ancient coin image according to the ancient coin type identifier of the first ancient coin training image, and an ancient coin type identifier of the second ancient coin training images is obtained.

For each of the ancient coin sub-images of the ancient coin training image, a multi-granularity feature alignment metric between each of the ancient coin sub-images and the ancient coin training image to which each of the ancient coin sub-images belongs is calculated according to the fine-grained image feature of each of the ancient coin sub-images and the coarse-grained image feature of the ancient coin training image to which each of the ancient coin sub-images belongs.

Iterative optimization is performed on a parameter of the ancient coin identification model according to the multi-granularity feature alignment metric and the ancient coin type identifier of the second ancient coin training images, and the target ancient coin identification model is obtained.

In an embodiment of the present disclosure, illustratively, the server obtains predefined ancient coin identification model architecture from a storage device, which is like a “framework” waiting to be filled with knowledge. Meanwhile, the server acquires a large number of sample ancient coin images from different channels, such as ancient coin photo libraries of museums and imaging data from archaeological excavation sites. The ancient coin training images in the sample ancient coin images are divided into first ancient coin training images and second ancient coin training images. The first ancient coin training images are labeled with corresponding ancient coin type identifiers by professionals, such as an ancient coin image labeled as “Qianlong Tongbao of the Qing Dynasty”, while the second ancient coin training images are unlabeled. For each ancient coin training image, the server performs region division by using an image segmentation algorithm. Taking a round ancient coin with a square hole as an example, the server divides it into a plurality of ancient coin sub-images, such as dividing the square hole part, character area, edge pattern area, etc., into separate ancient coin sub-images. The purpose of this is to analyze different features of the ancient coin in more detail. The server performs feature extraction on the ancient coin training image and each of its ancient coin sub-images through the ancient coin identification model. For the ancient coin training image, the server obtains its overall shape, size, and other visual features in the visual feature domain, as well as its inscription feature such as general character content in the semantic feature domain, and obtains the coarse-grained image feature of the ancient coin training image through cross-domain feature integration and gated recurrent unit (GRU)-based feature interaction, just like grasping the “overall outline” of the ancient coin. For each ancient coin sub-image, the server also obtains its sub-features in the visual and semantic feature domains, and obtains the corresponding fine-grained image feature via processing, just like understanding the “detailed texture” of the ancient coin in depth. The server performs contrastive learning on the coarse-grained image features of all ancient coin training images according to the ancient coin type identifiers of the first ancient coin training images. For example, the server sets category cardinality-based ancient coin type templates, and calculates the feature matching degree between the coarse-grained image feature of each ancient coin training image and each template. If the coarse-grained image feature of an unlabeled ancient coin training image has a high feature matching degree with that of an ancient coin training image labeled as “Kaiyuan Tongbao of the Tang Dynasty”, the server adds it to the ancient coin type pool corresponding to “Kaiyuan Tongbao of the Tang Dynasty”. Through continuous iteration, the server determines the ancient coin type template that meets the feature fluctuation threshold range, and then obtains ancient coin type identifiers corresponding to the second ancient coin training images. For each of the ancient coin sub-images of the ancient coin training image, the server calculates the multi-granularity feature alignment metric between the ancient coin sub-image and the ancient coin training image according to the fine-grained image feature of the ancient coin sub-image and the coarse-grained image feature of the ancient coin training image. For example, if the ancient coin sub-image is a character area on the ancient coin, the server analyzes the matching degree between the detailed feature of the character and the overall feature of the ancient coin to determine the multi-granularity feature alignment metric. The server performs iterative optimization on the parameter of the ancient coin identification model according to the multi-granularity feature alignment metric and the ancient coin type identifiers corresponding to the second ancient coin training images. The server calculates the coarse-grained error parameter and fine-grained error parameter, and continuously adjusts the parameter of the model according to these error parameters to improve the identification accuracy of the model. After a plurality of iterations, the server obtains the target ancient coin identification model, which can identify the types of ancient coins more accurately.

In an embodiment of the present disclosure, the process that contrastive learning is performed on the coarse-grained image feature of each of the ancient coin training images of the sample ancient coin image according to the ancient coin type identifier of the first ancient coin training image, and an ancient coin type identifier of the second ancient coin training image is obtained is implemented according to the following example.

Category cardinality-based ancient coin type templates are set, and a feature matching degree between the coarse-grained image feature of each of the ancient coin training images of the sample ancient coin image and each of the ancient coin type templates is calculated.

For each of the ancient coin training images, a target ancient coin type template feature-neighboring the ancient coin training image is determined from the ancient coin type templates according to the feature matching degree and the ancient coin type identifier of the first ancient coin training image, and the ancient coin training image is added to an ancient coin type pool corresponding to the target ancient coin type template.

For an ancient coin type pool corresponding to each of the ancient coin type templates, an ancient coin training image with highest type representativeness is selected from the ancient coin type pool as an evolved ancient coin type template.

The step of calculating the feature matching degree between the coarse-grained image feature of each of the ancient coin training images of the sample ancient coin image and each of the ancient coin type templates is repeated until the determined ancient coin type template meets a feature fluctuation threshold range. According to the ancient coin type identifier of the first ancient coin training image in a target ancient coin image set corresponding to the ancient coin type template that meets the feature fluctuation threshold range, the ancient coin type identifier of the second ancient coin training images in the target ancient coin image set is determined.

In an embodiment of the present disclosure, illustratively, the server first sets the category cardinality-based ancient coin type templates according to known ancient coin types. These templates are like standard reference samples, covering typical features of ancient coins of different dynasties and shapes. For example, for common ancient coin types such as Wuzhu coins of the Han Dynasty, Kaiyuan Tongbao of the Tang Dynasty, and Daguan Tongbao of the Song Dynasty, the server extracts representative features from a large number of labeled first ancient coin training images to construct corresponding ancient coin type templates. Next, for each of the ancient coin training images of the sample ancient coin image, the server extracts their coarse-grained image features. The coarse-grained image features include the overall outline, general shape, color distribution, and other information of the ancient coin. The server determines the similarity between the ancient coin training image and each template by calculating the feature matching degree between these coarse-grained image features and each of the ancient coin type templates. When calculating the feature matching degree, the server adopts methods such as cosine similarity and Euclidean distance. For example, for an ancient coin training image, the server calculates the cosine similarity between its coarse-grained image feature vector and the feature vector of the Wuzhu coin of the Han Dynasty template as 0.7, and the cosine similarity between its coarse-grained image feature vector and the feature vector of the Kaiyuan Tongbao of the Tang Dynasty template as 0.3. This indicates that the ancient coin training image has a high feature matching degree with the Wuzhu coin of the Han Dynasty template. For each ancient coin training image, the server determines a target ancient coin type template feature-neighboring the ancient coin training image from all ancient coin type templates according to the calculated feature matching degree and the ancient coin type identifier of the first ancient coin training image. If an ancient coin training image has the highest feature matching degree with the Wuzhu coin of the Han Dynasty template, and it is known that the identifier of Wuzhu coins of the Han Dynasty in the first ancient coin training images is “Han-Wuzhu”, then the server determines that the ancient coin training image is feature-neighboring Wuzhu coins of the Han Dynasty. Subsequently, the server adds the ancient coin training image to the ancient coin type pool corresponding to the target ancient coin type template. For example, for an ancient coin training image determined to be feature-neighboring Wuzhu coins of the Han Dynasty, the server adds it to the ancient coin type pool corresponding to the Wuzhu coin of the Han Dynasty template. In this way, each ancient coin type pool gradually gathers ancient coin training images similar to the characteristics of the ancient coin type. For an ancient coin type pool corresponding to each of the ancient coin type templates, the server needs to select the ancient coin training image with the highest type representativeness from it as the evolved ancient coin type template. The server comprehensively considers factors such as feature stability of the ancient coin training image and similarity to other images. For example, in the ancient coin type pool of Wuzhu coins of the Han Dynasty, the server analyzes the coarse-grained image features of each ancient coin training image to find those images with the most typical features that can represent the general features of Wuzhu coins of the Han Dynasty. Assuming that the shape, characters, perforation, and other features of one of the ancient coin training images are highly consistent with those of most Wuzhu coins of the Han Dynasty, and the feature changes under different angles and illumination conditions are small, then the server takes this image as the evolved ancient coin type template for Wuzhu coins of the Han Dynasty. The server repeats the step of calculating the feature matching degree between the coarse-grained image features of each ancient coin training image in the sample ancient coin images and each of the ancient coin type templates. With the continuous evolution of ancient coin type templates, the server continuously updates the target ancient coin type template and ancient coin type pool to which each ancient coin training image belongs. This process will continue until the determined ancient coin type template meets a feature fluctuation threshold range. The feature fluctuation threshold range is a standard preset by the server to measure the stability of ancient coin type templates. When the feature change range of the ancient coin type template is less than the threshold after a plurality of iterations, it indicates that the template is relatively stable. Finally, the server determines the ancient coin type identifiers of the second ancient coin training images in the target ancient coin image set according to the ancient coin type identifiers of the first ancient coin training images in the target ancient coin image set corresponding to the ancient coin type template that meets the feature fluctuation threshold range. For example, in the target ancient coin image set corresponding to the stable ancient coin type template for Wuzhu coins of the Han Dynasty, it is known that the identifiers of some first ancient coin training images are “Han-Wuzhu”, then the server also labels the second ancient coin training images in the image set as “Han-Wuzhu”. In this way, the server completes the labeling of the second ancient coin training images, providing more abundant labeled data for the subsequent training of the ancient coin identification model.

In an embodiment of the present disclosure, the process that contrastive learning is performed on the coarse-grained image feature of each of the ancient coin training images of the sample ancient coin image according to the ancient coin type identifier of the first ancient coin training image, and an ancient coin type identifier of the second ancient coin training image is obtained is implemented according to the following example.

A sample feature matching degree between every two ancient coin training images is determined according to the coarse-grained image features of the every two ancient coin training images.

An ancient coin association hypergraph is constructed according to the sample feature matching degree, where the ancient coin association hypergraph represents an association topology between the ancient coin training images.

Type feature propagation processing is performed on the ancient coin type identifier of the first ancient coin training image according to the ancient coin association hypergraph, and the ancient coin type identifier of the second ancient coin training images is obtained.

In an embodiment of the present disclosure, illustratively, the server first obtains the coarse-grained image features of all ancient coin training images in the sample ancient coin images. These coarse-grained image features include macroscopic information such as the overall shape, approximate size, and color distribution of the ancient coins. The server performs a detailed comparison of the coarse-grained image features of every two ancient coin training images. For example, among numerous ancient coin training images, one image is an ancient coin of Kaiyuan Tongbao of the Tang Dynasty, and another is an ancient coin of Xining Yuanbao of the Song Dynasty. The server extracts the coarse-grained features of the Kaiyuan Tongbao ancient coin training image, such as round shape with a square hole, front-side character layout, and rust color distribution. Meanwhile, it extracts the corresponding features of the Xining Yuanbao ancient coin training image. Then, the server uses specific similarity calculation methods, such as cosine similarity and Euclidean distance, to determine the sample feature matching degree between the two ancient coin training images. If the calculated cosine similarity between the two images is 0.3, it indicates that their feature matching degree is relatively low. The server performs such calculation for all pairs of ancient coin training images, thereby obtaining a comprehensive sample feature matching degree matrix, which records the feature similarity between any two ancient coin training images. The server constructs an ancient coin association hypergraph according to the calculated sample feature matching degree. The ancient coin association hypergraph is a graph structure configured to represent complex relationships between ancient coin training images, and it includes feature units and topological connections. Each ancient coin training image corresponds to one feature unit, and the feature unit includes the coarse-grained image feature information of the ancient coin training image. The topological connection represents the association topology between two connected feature units, and its weight is determined by the sample feature matching degree. For example, if the sample feature matching degree of two ancient coin training images is high, the weight of the topological connection between their feature units is large, which means that the two ancient coins are more similar in features and have a closer association. On the contrary, if the sample feature matching degree is low, the weight of the topological connection is small. Assuming that the server has 100 ancient coin training images, it will establish corresponding topological connections for these 100 feature units. For pairs of Kaiyuan Tongbao ancient coin training images with high feature matching degree, the server connects their corresponding feature units with thicker lines (indicating larger weights), while for image pairs with low feature matching degree such as Kaiyuan Tongbao and Xining Yuanbao, their feature units are connected with thinner lines. In this way, the server constructs a complete ancient coin association hypergraph, which clearly shows the association topology between each ancient coin training image. The server uses the constructed ancient coin association hypergraph to perform type feature propagation processing on the ancient coin type identifier of the first ancient coin training image, so as to determine the ancient coin type identifiers corresponding to the second ancient coin training images. Starting from the feature units of the labeled first ancient coin training images in the ancient coin association hypergraph, the server propagates the feature information of their ancient coin type identifiers to other connected feature units through the topological connections between the feature units. For example, for a first ancient coin training image clearly labeled as “Kaiyuan Tongbao of the Tang Dynasty”, the server transmits the feature information of the type identifier “Kaiyuan Tongbao of the Tang Dynasty” to neighboring feature units along the topological connections connected to it. For the feature units of the neighboring second ancient coin training images, the server initially determines their reference ancient coin type identifiers according to the received type feature information and the association between the feature units and other feature units. Then, for each second ancient coin training image, the server performs predictive iterative optimization on the reference ancient coin type identifier according to the neighboring feature units of the second ancient coin training image in the ancient coin association hypergraph. This process is repeated continuously until the results of the feature units in the ancient coin association hypergraph are stably determined. For example, after a plurality of iterations, a feature unit of a second ancient coin training image receives type feature information from a plurality of “Kaiyuan Tongbao of the Tang Dynasty” feature units, and its own features are increasingly matched with those of these “Kaiyuan Tongbao of the Tang Dynasty” feature units, then the server finally determines that the ancient coin type identifier of the second ancient coin training image is “Kaiyuan Tongbao of the Tang Dynasty”. Through such type feature propagation and iterative optimization process, the server determines the corresponding ancient coin type identifiers for all second ancient coin training images.

In an embodiment of the present disclosure, the ancient coin association hypergraph includes feature units corresponding to each of the ancient coin training images and a topological connection between the feature units. The topological connection represents the association topology between every two connected feature units.

In an embodiment of the present disclosure, the process that type feature propagation processing is performed on the ancient coin type identifier of the first ancient coin training image according to the ancient coin association hypergraph, and the ancient coin type identifier of the second ancient coin training image is obtained is implemented according to the following example.

Type feature propagation processing is performed on the ancient coin type identifier of the first ancient coin training image through the topological connection between the feature units in the ancient coin association hypergraph to determine a reference ancient coin type identifier of the second ancient coin training images.

For each of the second ancient coin training images, predictive iterative optimization is performed on the reference ancient coin type identifier of the second ancient coin training image according to a neighboring feature unit of the second ancient coin training image in the ancient coin association hypergraph until a result of the feature unit in the ancient coin association hypergraph is stably determined, and the ancient coin type identifier of the second ancient coin training image is obtained.

In an embodiment of the present disclosure, illustratively, the server has first constructed the ancient coin association hypergraph including feature units corresponding to each ancient coin training image and topological connections between the feature units. The existence of topological connections reflects the association topology between two connected feature units, and the closeness of this association topology is determined by the previously calculated sample feature matching degree. In this hypergraph, the server starts type feature propagation from the feature units corresponding to the first ancient coin training images labeled with ancient coin type identifiers. For example, among numerous ancient coin training images, there is a first ancient coin training image clearly labeled as “Wuzhu Coin of the Han Dynasty”, and its corresponding feature unit stores the coarse-grained image feature of the ancient coin and the type identifier “Wuzhu Coin of the Han Dynasty”. The server transmits the feature information of the type identifier “Wuzhu Coin of the Han Dynasty” to neighboring feature units along the topological connections of the feature unit. Assuming that a feature unit neighboring the “Wuzhu Coin of the Han Dynasty” feature unit corresponds to an unlabeled second ancient coin training image, then after the server transmits the type feature information of “Wuzhu Coin of the Han Dynasty”, it initially determines the reference ancient coin type identifier of the second ancient coin training image as “Suspected Wuzhu Coin of the Han Dynasty” according to the received information and the coarse-grained image feature of the feature unit itself. The server performs such type feature propagation operation on all feature units corresponding to the first ancient coin training images, so as to determine the initial reference ancient coin type identifiers for all second ancient coin training images. For each second ancient coin training image, the server performs predictive iterative optimization on the reference ancient coin type identifier according to the neighboring feature units of the second ancient coin training image in the ancient coin association hypergraph. Taking the second ancient coin training image initially determined as “Suspected Wuzhu Coin of the Han Dynasty” as an example, the server examines other neighboring feature units of the second ancient coin training image in the ancient coin association hypergraph. If many of the neighboring feature units correspond to the clearly labeled first ancient coin training images of “Wuzhu Coin of the Han Dynasty”, and the weights of the topological connections between these feature units and the feature unit of the second ancient coin training image are large (i.e., the sample feature matching degree is high), then the server improves the credibility of the type identifier “Wuzhu Coin of the Han Dynasty”. On the contrary, if some of the neighboring feature units correspond to ancient coin training images of other types, and there is a certain association between these feature units and the feature unit of the second ancient coin training image (the topological connections have a certain weight), the server comprehensively considers such information to adjust the reference ancient coin type identifier. For example, it may be adjusted to “Wuzhu Coin of the Han Dynasty or other similar ancient coins to be further confirmed”. The server will continuously repeat this predictive iterative optimization process. Each iteration will comprehensively consider the information of more neighboring feature units to make a more accurate adjustment of the reference ancient coin type identifier. In this process, the server examines whether the results of each feature unit in the ancient coin association hypergraph are stable. The so-called stable determination of results means that after a plurality of iterations, the ancient coin type identifier corresponding to each feature unit no longer changes significantly. For example, after a plurality of iterations, the reference ancient coin type identifier corresponding to the feature unit of the second ancient coin training image is stably “Wuzhu Coin of the Han Dynasty”, and its association with the surrounding “Wuzhu Coin of the Han Dynasty” feature units remains stable, then the server can determine that the result is stable. At this time, the server determines that the ancient coin type identifier of the second ancient coin training image is “Wuzhu Coin of the Han Dynasty”. The server performs such iterative optimization process for all second ancient coin training images until the results of all feature units are stably determined, so as to determine the final corresponding ancient coin type identifiers for all second ancient coin training images.

In an embodiment of the present disclosure, the process that for each of the ancient coin sub-images of the ancient coin training image, a multi-granularity feature alignment metric between each of the ancient coin sub-images and the ancient coin training image to which each of the ancient coin sub-images belongs according to the fine-grained image feature of each of the ancient coin sub-images and the coarse-grained image feature of the ancient coin training image to which each of the ancient coin sub-images belongs is implemented according to the following example.

A coarse-grained feature set is constructed according to the coarse-grained image feature of each of the ancient coin training images, and a fine-grained feature set is constructed according to the fine-grained image feature of the ancient coin sub-image of each of the ancient coin training images.

For each of the ancient coin training images, at least one neighboring coarse-grained image feature neighboring the coarse-grained image feature of the ancient coin training image is traversed in the coarse-grained feature set, and a category candidate of the ancient coin training image is determined according to an ancient coin type identifier of the ancient coin training image to which the neighboring coarse-grained image feature belongs.

For each of the ancient coin sub-images of the ancient coin training image, at least one neighboring fine-grained image feature neighboring the fine-grained image feature of the ancient coin sub-image is traversed in the fine-grained feature set, and a category candidate of the ancient coin sub-image is determined according to the ancient coin type identifier of the ancient coin training image to which the neighboring fine-grained image feature belongs.

A multi-granularity feature alignment metric between each of the ancient coin sub-images and the ancient coin training image to which each of the ancient coin sub-images belongs is calculated according to the category candidate of each of the ancient coin sub-images and the category candidate of the ancient coin training image to which each of the ancient coin sub-images belongs.

In an embodiment of the present disclosure, illustratively, the server has obtained the coarse-grained image features of all ancient coin training images and the fine-grained image features of each ancient coin sub-image. The coarse-grained image features include macroscopic information such as the overall shape, approximate size, and color distribution of the ancient coins. The fine-grained image features include microscopic information such as the detailed texture, local patterns, and character strokes of the ancient coin sub-images. The server integrates the coarse-grained image features of all ancient coin training images to construct a coarse-grained feature set. For example, if there are 100 ancient coin training images, the server combines these 100 coarse-grained image features into one set. Similarly, the server integrates the fine-grained image features of all ancient coin sub-images to construct a fine-grained feature set. If these 100 ancient coin training images are divided into 500 ancient coin sub-images in total, the server incorporates the 500 fine-grained image features into the fine-grained feature set. For each ancient coin training image, the server performs traversal in the coarse-grained feature set. Taking an ancient coin training image labeled as “Kaiyuan Tongbao of the Tang Dynasty” as an example, the server calculates the similarity between its coarse-grained image feature and other coarse-grained image features in the coarse-grained feature set, and finds out at least one feature-neighboring coarse-grained image feature. Assuming that a neighboring coarse-grained image feature with high similarity is found, and the ancient coin training image to which it belongs is also labeled as “Kaiyuan Tongbao of the Tang Dynasty”, then the server determines the category candidate of the ancient coin training image as “Kaiyuan Tongbao of the Tang Dynasty” according to the ancient coin type identifiers of the ancient coin training images to which these neighboring coarse-grained image features belong. The server performs such operation for all ancient coin training images, so as to determine category candidates for each ancient coin training image. For each of the ancient coin sub-images of the ancient coin training image, the server performs traversal in the fine-grained feature set. For example, the character area on an ancient coin training image is divided into an ancient coin sub-image, then the server calculates the similarity between the fine-grained image feature of the ancient coin sub-image and other fine-grained image features in the fine-grained feature set to find at least one neighboring fine-grained image feature. If the ancient coin training image to which this neighboring fine-grained image feature belongs is labeled as “Kaiyuan Tongbao of the Tang Dynasty”, the server determines the category candidate of each of the ancient coin sub-images as “Kaiyuan Tongbao of the Tang Dynasty”. The server performs such operation for all ancient coin sub-images of each ancient coin training image to determine their respective category candidates. The server calculates the multi-granularity feature alignment metric according to the category candidate of the ancient coin sub-image and the category candidate of the ancient coin training image to which the ancient coin sub-image belongs. Taking the ancient coin sub-image of the character area of an ancient coin training image of “Kaiyuan Tongbao of the Tang Dynasty” as an example, if the category candidate of the ancient coin sub-image and the category candidate of the ancient coin training image to which it belongs are both “Kaiyuan Tongbao of the Tang Dynasty”, it indicates that they are highly consistent in category. The server can measure the multi-granularity feature alignment metric by calculating the coincidence degree of the category candidates. If the category candidates are completely the same, the coincidence degree is 100%, and the multi-granularity feature alignment metric is high. If they are partially coincident, the server can determine the multi-granularity feature alignment metric according to the coincidence ratio. For example, if the category candidates of the ancient coin sub-image include “Kaiyuan Tongbao of the Tang Dynasty” and “a certain similar ancient coin of the Song Dynasty”, and the category candidate of the ancient coin training image to which it belongs is “Kaiyuan Tongbao of the Tang Dynasty”, then the coincidence degree is 50%, and the server can set the multi-granularity feature alignment metric as 50%. The server performs such calculation for each ancient coin sub-image and the ancient coin training image to which it belongs, so as to obtain all multi-granularity feature alignment metrics. These alignment metrics reflect the matching degree between the ancient coin sub-images and the ancient coin training image to which they belong in terms of features of different granularities, providing an important basis for the subsequent optimization of the ancient coin identification model.

In an embodiment of the present disclosure, the process that a multi-granularity feature alignment metric between each of the ancient coin sub-images and the ancient coin training image to which each of the ancient coin sub-images belongs is calculated according to the category candidate of each of the ancient coin sub-images and the category candidate of the ancient coin training image to which each of the ancient coin sub-images belongs is implemented according to the following example.

Probability distribution modeling is performed on the ancient coin type identifier of the category candidate of the ancient coin sub-image, and an ancient coin type confidence distribution of the ancient coin sub-image is determined.

Probability distribution modeling is performed on the ancient coin type identifier of the category candidate of the ancient coin training image to which the ancient coin sub-image belongs, and an ancient coin type confidence distribution of the ancient coin training image to which the ancient coin sub-image belongs is determined.

A multi-granularity feature alignment metric between the ancient coin sub-image and the ancient coin training image to which the ancient coin sub-image belongs is calculated according to the ancient coin type confidence distribution of the ancient coin sub-image and the ancient coin type confidence distribution of the ancient coin training image to which the ancient coin sub-image belongs.

In an embodiment of the present disclosure, illustratively, the server first focuses on the category candidates of the ancient coin sub-images. Assuming that an ancient coin sub-image is an image of the character area on the ancient coin, and its category candidates include “Kaiyuan Tongbao of the Tang Dynasty”, “Xining Yuanbao of the Song Dynasty”, and “Wuzhu Coin of the Han Dynasty”, then the server performs probability distribution modeling on these ancient coin type identifiers. The server will comprehensively consider the matching degree between the fine-grained image feature of the ancient coin sub-image and each category candidate. For example, through the analysis of the fine-grained features such as the font, style, and strokes of the characters, it is found that the similarity of its character features to those of “Kaiyuan Tongbao of the Tang Dynasty” is 70%, to those of “Xining Yuanbao of the Song Dynasty” is 20%, and to those of “Wuzhu Coin of the Han Dynasty” is 10%. Based on these similarities, the server constructs a probability distribution and determines that the ancient coin type confidence distribution of the ancient coin sub-image is as follows: the confidence for “Kaiyuan Tongbao of the Tang Dynasty” is 0.7, the confidence for “Xining Yuanbao of the Song Dynasty” is 0.2, and the confidence for “Wuzhu Coin of the Han Dynasty” is 0.1. This confidence distribution reflects the probability of the ancient coin sub-image belonging to each ancient coin type. Then, the server performs the same operation on the category candidates of the ancient coin training image to which the ancient coin sub-image belongs. Assuming that the category candidates of the ancient coin training image include “Kaiyuan Tongbao of the Tang Dynasty” and “Qianyuan Chongbao of the Tang Dynasty”, then the server analyzes the coarse-grained image features of the ancient coin training image, such as overall shape, size, and rust color distribution, and finds that the similarity of its coarse-grained features to those of “Kaiyuan Tongbao of the Tang Dynasty” is 80%, and the similarity to those of “Qianyuan Chongbao of the Tang Dynasty” is 20%. Based on these similarities, the server constructs a probability distribution and determines the ancient coin type confidence distribution of the ancient coin training image to which the ancient coin sub-image belongs as follows: the confidence for “Kaiyuan Tongbao of the Tang Dynasty” is 0.8, and the confidence for “Qianyuan Chongbao of the Tang Dynasty” is 0.2. This confidence distribution reflects the probability of the ancient coin training image belonging to each ancient coin type. After obtaining the ancient coin type confidence distribution of the ancient coin sub-image and the ancient coin type confidence distribution of the ancient coin training image to which it belongs, the server starts to calculate the multi-granularity feature alignment metric. The server will adopt a specific algorithm to measure the similarity between the two confidence distributions. A common method is to calculate the Kullback-Leibler (KL) divergence between the two distributions. The KL divergence can measure the degree of difference between two probability distributions. A smaller difference indicates that the two distributions are more similar. For the ancient coin sub-image and the ancient coin training image to which it belongs in the above example, the server calculates the KL divergence between their ancient coin type confidence distributions. If the calculated KL divergence value is small, it indicates that the two confidence distributions are relatively similar, which means that the ancient coin sub-image and the ancient coin training image to which it belongs are relatively consistent in terms of the probability of ancient coin types, and the multi-granularity feature alignment metric is relatively high. If the KL divergence value is large, it indicates that the two confidence distributions are quite different, and there is a large deviation between the ancient coin sub-image and the ancient coin training image to which it belongs in terms of the probability of ancient coin types, and the multi-granularity feature alignment metric is relatively low. In this way, the server calculates the multi-granularity feature alignment metric for each ancient coin sub-image and the ancient coin training image to which it belongs. These alignment metric data are very critical for the subsequent optimization of the ancient coin identification model, which can help the model better understand the relationship between features of different granularities of ancient coins and improve the accuracy of ancient coin type identification.

In an embodiment of the present disclosure, the process that iterative optimization is performed on a parameter of the ancient coin identification model according to the multi-granularity feature alignment metric and the ancient coin type identifier of the second ancient coin training images, and the target ancient coin identification model is obtained is implemented according to the following example.

Ancient coin type identification is performed on the ancient coin training image according to the coarse-grained image feature of the ancient coin training image, and a coarse-grained type confidence distribution corresponding to the ancient coin training image is obtained.

Ancient coin type identification is performed on the ancient coin sub-image according to the fine-grained image feature of the ancient coin sub-image, and a fine-grained type confidence distribution corresponding to the ancient coin sub-image is obtained.

Iterative optimization is performed on a parameter of the ancient coin identification model according to the coarse-grained type confidence distribution, the fine-grained type confidence distribution, the multi-granularity feature alignment metric and the ancient coin type identifier of the second ancient coin training images, and the target ancient coin identification model is obtained.

In an embodiment of the present disclosure, illustratively, the server first extracts the coarse-grained image features of the ancient coin training image, which include macroscopic information such as the overall shape, approximate size, and color distribution of the ancient coin. Taking an ancient coin training image as an example, its coarse-grained image features show that the ancient coin is round with a square hole, of medium overall size, and the rust color shows a certain indicative of its age. The server inputs these coarse-grained image features into the ancient coin identification model for ancient coin type identification. Based on the knowledge it has learned, the model will determine the possible ancient coin types of the ancient coin training image and give corresponding confidence. For example, after model identification, the coarse-grained type confidence distribution corresponding to the ancient coin training image is as follows: the confidence for “Kaiyuan Tongbao of the Tang Dynasty” is 0.6, the confidence for “Xining Yuanbao of the Song Dynasty” is 0.3, and the confidence for “Wuzhu Coin of the Han Dynasty” is 0.1. This distribution reflects the probability of the ancient coin training image belonging to each ancient coin type from the perspective of coarse-grained features. For each ancient coin sub-image of the ancient coin training image, the server extracts their fine-grained image features, which include microscopic information such as the detailed texture, local patterns, and character strokes of the ancient coin sub-image. For example, an ancient coin sub-image is the character area on the ancient coin, and its fine-grained image features show details such as the font style and stroke thickness of the characters, then the server inputs these fine-grained image features into the ancient coin identification model for ancient coin type identification. The model performs analysis and determination according to these fine-grained features and gives the fine-grained type confidence distribution corresponding to the ancient coin sub-image. For example, the fine-grained type confidence distribution corresponding to each of the ancient coin sub-images is as follows: the confidence for “Kaiyuan Tongbao of the Tang Dynasty” is 0.7, the confidence for “Xining Yuanbao of the Song Dynasty” is 0.2, and the confidence for “Wuzhu Coin of the Han Dynasty” is 0.1. This distribution reflects the probability of the ancient coin sub-image belonging to each ancient coin type from the perspective of fine-grained features. After obtaining the coarse-grained type confidence distribution, the fine-grained type confidence distribution, the multi-granularity feature alignment metric, and the ancient coin type identifiers corresponding to the second ancient coin training images, the server starts to perform iterative optimization on the parameter of the ancient coin identification model. First, the server compares the coarse-grained type confidence distribution with the ancient coin type identifiers corresponding to the second ancient coin training images. If the ancient coin type identifier of the second ancient coin training image is “Kaiyuan Tongbao of the Tang Dynasty”, while the confidence for “Kaiyuan Tongbao of the Tang Dynasty” in the coarse-grained type confidence distribution is 0.6, there is a certain deviation. According to this deviation, the server adjusts a parameter related to coarse-grained feature processing in the model, such that the model can more accurately determine the ancient coin type when subsequently identifying ancient coin training images with similar coarse-grained features. Then, the server compares the fine-grained type confidence distribution with the ancient coin type identifiers corresponding to the second ancient coin training images. If there is a difference between them, the server adjusts a parameter related to fine-grained feature processing in the model to improve the model's ability to identify fine-grained features. The multi-granularity feature alignment metric is also an important basis for optimization. If the multi-granularity feature alignment metric is low, it indicates that the matching degree between the ancient coin sub-image and the ancient coin training image to which it belongs in terms of features of different granularities is low. The server adjusts a parameter in the model for fusing coarse-grained and fine-grained features, such that the model can better understand the relationship between features of different granularities and improve the alignment metric of multi-granularity features. The server will continuously repeat the above iterative optimization process, and adjust the model parameter according to new identification results and known information in each iteration. After a plurality of iterations, the parameter of the model gradually converges, and the accuracy of ancient coin type identification is continuously improved, finally obtaining the target ancient coin identification model, which can more accurately identify the types of ancient coins.

In an embodiment of the present disclosure, the process that iterative optimization is performed on a parameter of the ancient coin identification model according to the coarse-grained type confidence distribution, the fine-grained type confidence distribution, the multi-granularity feature alignment metric and the ancient coin type identifier of the second ancient coin training images, and the target ancient coin identification model is obtained is implemented according to the following example.

For each of the ancient coin training images, the ancient coin type identifier of each of the ancient coin training images is calibrated according to the fine-grained type confidence distribution of each of the ancient coin sub-images of the ancient coin training image and the multi-granularity feature alignment metric corresponding to each of the ancient coin sub-images, and a calibrated ancient coin type identifier of each of the ancient coin training images is obtained.

The calibrated ancient coin type identifier of each of the ancient coin training images is integrated according to the coarse-grained type confidence distribution corresponding to each of the ancient coin training images, and a coarse-grained error parameter is obtained.

Iterative optimization is performed on the parameter of the ancient coin identification model according to the coarse-grained error parameter, and the target ancient coin identification model is obtained.

In an embodiment of the present disclosure, illustratively, the server performs processing on each ancient coin training image. Taking an ancient coin training image labeled as “Chongning Tongbao of the Song Dynasty” as an example, the image is divided into a plurality of ancient coin sub-images such as a character area and an edge pattern area. The server first examines the fine-grained type confidence distribution of each ancient coin sub-image. For example, the fine-grained type confidence distribution of the ancient coin sub-image of the character area is as follows: the confidence for “Chongning Tongbao of the Song Dynasty” is 0.8, the confidence for “Kaiyuan Tongbao of the Tang Dynasty” is 0.1, and the confidence for “Wuzhu Coin of the Han Dynasty” is 0.1. Meanwhile, the multi-granularity feature alignment metric corresponding to the ancient coin sub-image of the character area is 0.9, which indicates that it has a high matching degree with the ancient coin training image to which it belongs in terms of multi-granularity features. The server calibrates the ancient coin type identifier of the ancient coin training image by comprehensively considering the fine-grained type confidence distribution and multi-granularity feature alignment metric of all ancient coin sub-images. If the fine-grained type confidence distribution of most ancient coin sub-images points to “Chongning Tongbao of the Song Dynasty” and the multi-granularity feature alignment metric is high, the server confirms that the calibrated ancient coin type identifier of the ancient coin training image is still “Chongning Tongbao of the Song Dynasty”. However, if the fine-grained type confidence distribution of some ancient coin sub-images is quite different from the original identifier and the multi-granularity feature alignment metric is also low, the server will perform re-evaluation and may adjust the calibrated ancient coin type identifier to a type more consistent with the overall features. The server then integrates the calibrated ancient coin type identifiers of each of the ancient coin training images according to the coarse-grained type confidence distribution corresponding to each of the ancient coin training images. Taking the ancient coin training image of “Chongning Tongbao of the Song Dynasty” as an example again, its coarse-grained type confidence distribution is as follows: the confidence for “Chongning Tongbao of the Song Dynasty” is 0.7, the confidence for “Daguan Tongbao of the Song Dynasty” is 0.2, and the confidence for “Qianyuan Chongbao of the Tang Dynasty” is 0.1. The server compares this coarse-grained type confidence distribution with the calibrated ancient coin type identifier “Chongning Tongbao of the Song Dynasty”. The server calculates the difference between them, for example, by using a cross-entropy loss function to measure such difference. The cross-entropy loss function can reflect the error between the coarse-grained type confidence distribution predicted by the model and the actual calibrated ancient coin type identifier. The server performs such calculation for all ancient coin training images, and then integrates these errors to obtain a coarse-grained error parameter. This parameter reflects the overall error of the model in ancient coin type identification at the coarse-grained level. After obtaining the coarse-grained error parameter, the server starts to perform iterative optimization on the parameter of the ancient coin identification model. The server adopts an optimization algorithm such as a gradient descent algorithm to adjust the parameter of the model according to the coarse-grained error parameter. The gradient descent algorithm calculates the gradient of the error parameter with respect to the model parameter, and then updates the model parameter in the direction opposite to the gradient, such that the error parameter gradually decreases. In each iteration process, the server applies the new parameter to the model, re-identifies the ancient coin training images to obtain new coarse-grained type confidence distributions and fine-grained type confidence distributions, and then repeats the above steps of calibrating ancient coin type identifiers and integrating to obtain the coarse-grained error parameter. As the number of iterations increases, the coarse-grained error parameter will become increasingly small, and the identification accuracy of the model will continue to improve. After a plurality of iterative optimizations, when the coarse-grained error parameter converges to a relatively small value or a preset number of iterations is reached, the server deems the model sufficiently trained, yielding the target ancient coin identification model capable of identifying ancient coin types more accurately.

In an embodiment of the present disclosure, the process that iterative optimization is performed on the parameter of the ancient coin identification model according to the coarse-grained error parameter, and the target ancient coin identification model is obtained is implemented according to the following example.

A fine-grained category error parameter of each of the ancient coin sub-images is calculated according to the fine-grained type confidence distribution of each of the ancient coin sub-images and the ancient coin type identifier of the ancient coin training image to which each of the ancient coin sub-images belongs.

Iterative optimization is performed on the parameter of the ancient coin identification model according to the coarse-grained error parameter and the fine-grained category error parameter, and the target ancient coin identification model is obtained.

In an embodiment of the present disclosure, illustratively, the server takes an ancient coin training image labeled as “Kaiyuan Tongbao of the Tang Dynasty” as an example, and the image includes a plurality of ancient coin sub-images such as a character area and an edge pattern area. For the ancient coin sub-image of the character area, its fine-grained type confidence distribution is as follows: the confidence for “Kaiyuan Tongbao of the Tang Dynasty” is 0.7, the confidence for “Xining Yuanbao of the Song Dynasty” is 0.2, and the confidence for “Wuzhu Coin of the Han Dynasty” is 0.1. The server calculates the fine-grained category error parameter of the ancient coin sub-image according to the fine-grained type confidence distribution and the ancient coin type identifier “Kaiyuan Tongbao of the Tang Dynasty” of the ancient coin training image to which the ancient coin sub-image belongs. The server uses a cross-entropy loss function to measure the difference between them. The cross-entropy loss function takes into account the matching degree between the confidence for each ancient coin type in the fine-grained type confidence distribution and the actual identifier. In this example, the actual identifier of “Kaiyuan Tongbao of the Tang Dynasty” corresponds to a confidence of 0.7 in the fine-grained type confidence distribution, and the server calculates the error value between them through the function. The server performs such calculation for all ancient coin sub-images of the ancient coin training image to obtain the fine-grained category error parameter of each ancient coin sub-image. Thus, the server has obtained the coarse-grained error parameter and the fine-grained category error parameter of each ancient coin sub-image. The server combines these two types of error parameters to perform iterative optimization on the parameter of the ancient coin identification model. The server adopts the gradient descent algorithm, which is a commonly used optimization algorithm. The server first calculates the gradients of the coarse-grained error parameter and all fine-grained category error parameters with respect to the model parameter. The gradient represents the rate of change of the error parameter as the model parameter changes. The server updates the model parameter in the direction opposite to the gradient, such that the error parameters gradually decrease. In each iteration, the server applies the new parameter to the model, re-identifies the ancient coin training images and ancient coin sub-images to obtain new coarse-grained type confidence distributions and fine-grained type confidence distributions. Then, the server calculates the coarse-grained error parameter and fine-grained category error parameter again. As the number of iterations increases, both the coarse-grained error parameter and the fine-grained category error parameter continue to decrease. When the error parameters converge to a relatively small value or a preset number of iterations is reached, the server deems the model sufficiently trained. Thus, the server obtains the target ancient coin identification model, which can comprehensively consider the coarse-grained and fine-grained features of ancient coins and identify ancient coin types more accurately.

In an embodiment of the present disclosure, the process that iterative optimization is performed on the parameter of the ancient coin identification model according to the coarse-grained error parameter and the fine-grained category error parameter, and the target ancient coin identification model is obtained is implemented according to the following example.

Distribution difference calculation processing is performed between the fine-grained type confidence distribution of each of the ancient coin sub-images and a reference distribution, and a feature difference metric corresponding to each of the ancient coin sub-images is obtained.

The fine-grained category error parameter and the feature difference metric are integrated according to the multi-granularity feature alignment metric corresponding to each of the ancient coin sub-images, and a fine-grained error parameter of each of the ancient coin sub-images is obtained.

Iterative optimization is performed on the parameter of the ancient coin identification model according to the coarse-grained error parameter and the fine-grained error parameter of each of the ancient coin sub-images of the ancient coin training image, and the target ancient coin identification model is obtained.

In an embodiment of the present disclosure, illustratively, the server takes an ancient coin training image labeled as “Wuzhu Coin of the Han Dynasty” as an example, and the image has a plurality of ancient coin sub-images such as characters and outlines. For the ancient coin sub-image of the character area, its fine-grained type confidence distribution is as follows: the confidence for “Wuzhu Coin of the Han Dynasty” is 0.6, the confidence for “Kaiyuan Tongbao of the Tang Dynasty” is 0.3, and the confidence for “Yuanfeng Tongbao of the Song Dynasty” is 0.1. The server presets a reference distribution, which reflects the characteristic distribution that the ancient coin sub-image of “Wuzhu Coin of the Han Dynasty” should have in an ideal state. The server uses a method such as KL divergence to perform distribution difference calculation processing between the fine-grained type confidence distribution of the ancient coin sub-image of the character area and the reference distribution. Through calculation, the server obtains a feature difference metric corresponding to the ancient coin sub-images and this index quantifies the degree of difference between the actual feature distribution of the ancient coin sub-image and the ideal distribution. The server obtains the multi-granularity feature alignment metric of 0.8 corresponding to the ancient coin sub-image of the character area, as well as the previously calculated fine-grained category error parameter. The server integrates the fine-grained category error parameter and the feature difference metric according to the multi-granularity feature alignment metric. If the multi-granularity feature alignment metric is high, it indicates that the ancient coin sub-image has a good match with the ancient coin training image to which it belongs in terms of multi-granularity features, and in this case, relatively large weights are assigned to the fine-grained category error parameter and the feature difference metric during integration. Otherwise, relatively small weights are assigned. The server performs the integration to obtain the fine-grained error parameter of the ancient coin sub-image through methods such as weighted summation. The server performs such operation for all ancient coin sub-images of the ancient coin training image to obtain the fine-grained error parameter of each ancient coin sub-image. After obtaining the coarse-grained error parameter and the fine-grained error parameter of each of the ancient coin sub-images, the server adopts an optimization algorithm such as gradient descent to perform iterative optimization on the parameter of the ancient coin identification model. The server calculates the gradients of these error parameters with respect to the model parameter, and updates the model parameter in the direction opposite to the gradients, thereby continuously reducing the error parameters. In each iteration, the server re-evaluates the identification effect of the model and updates the coarse-grained error parameter and fine-grained error parameter. After a plurality of iterations, when the error parameters converge to a relatively small value or a preset number of iterations is reached, the server deems the model completely trained, yielding the target ancient coin identification model capable of identifying ancient coin types more accurately.

In an embodiment of the present disclosure, the process that feature extraction processing performed by the ancient coin identification model on the ancient coin training image and each of the ancient coin sub-images of the ancient coin training image, and a coarse-grained image feature of the ancient coin training image and a fine-grained image feature of each of the ancient coin sub-images are obtained is implemented according to the following example.

For the ancient coin training image, a visual feature set in a visual feature domain and an inscription feature set in a semantic feature domain are obtained, and for each of the ancient coin sub-images of the ancient coin training image, a visual sub-feature set in the visual feature domain and an inscription sub-feature set in the semantic feature domain are obtained.

Cross-domain feature integration processing is performed on the visual feature set and the inscription feature set of the ancient coin training images, and a multi-dimensional feature set of the ancient coin training images is obtained. Cross-domain feature integration processing is performed on the visual sub-feature set and the inscription sub-feature set of each of the ancient coin sub-images, and a multi-dimensional feature set of each of the ancient coin sub-images is obtained.

GRU-based feature interaction is performed by the ancient coin identification model on the multi-dimensional feature set of the ancient coin training images, and the coarse-grained image feature of the ancient coin training images is obtained.

GRU-based feature interaction is performed by the ancient coin identification model on the multi-dimensional feature set of each of the ancient coin sub-images, and the fine-grained image feature of each of the ancient coin sub-images is obtained.

In an embodiment of the present disclosure, illustratively, the server first processes an ancient coin training image, which represents an unearthed ancient coin of Kaiyuan Tongbao of the Tang Dynasty. In terms of the visual feature domain, the server uses image analysis technology to obtain the visual feature set of the ancient coin training image. For example, it identifies that the ancient coin is round with a square hole as a whole, measures the diameter of the ancient coin, analyzes the distribution of rust color on its surface, and these visual features together form the visual feature set. In the semantic feature domain, the server extracts the inscription feature set of the ancient coin with the help of technologies such as optical character recognition (OCR), identifies the four characters “Kaiyuan Tongbao” on the front of the ancient coin, including information such as the font and stroke thickness of the characters. The server also performs feature acquisition for each ancient coin sub-image divided from the ancient coin training image. Taking the sub-image of the character area on the ancient coin as an example, in the visual feature domain, the server obtains the visual sub-feature set including the edge clarity and color contrast of the characters in the sub-image. In the semantic feature domain, it obtains the inscription sub-feature set including the specific shape and stroke trend of individual characters in the sub-image. The server performs cross-domain feature integration processing on the visual feature set and the inscription feature set of the ancient coin training image. It fuses the visual features such as the round square-hole shape and rust color distribution with the semantic information of the inscription “Kaiyuan Tongbao”. The server adopts methods such as feature concatenation to combine the visual features and inscription features to form a multi-dimensional feature set of the ancient coin training image. This multi-dimensional feature set comprehensively includes information from both visual and semantic aspects, and describes the ancient coin of Kaiyuan Tongbao of the Tang Dynasty more comprehensively. The server also performs cross-domain feature integration processing on the visual sub-feature set and inscription sub-feature set of the ancient coin sub-image. Taking the sub-image of the character area as an example again, the server fuses the visual sub-features such as the edge clarity of the characters with the inscription sub-features such as the stroke trend of individual characters to obtain a multi-dimensional feature set of the ancient coin sub-image. The server inputs the multi-dimensional feature set of the ancient coin training image into a GRU in the ancient coin identification model for feature interaction. The GRU can process sequence data, and perform analysis and interaction according to the relationships between various feature elements in the multi-dimensional feature set. When processing the multi-dimensional feature set of the ancient coin training image of the ancient coin “Kaiyuan Tongbao of the Tang Dynasty”, the GRU considers the correlation between visual features and inscription features. For example, the rust color distribution may affect the identification clarity of inscriptions, and the GRU will learn this correlation and perform feature interaction. After processing by the GRU, the server obtains the coarse-grained image features of the ancient coin training image. These coarse-grained image features include the overall macroscopic information of the ancient coin. For example, the overall style is more in line with the casting characteristics of the Tang Dynasty, so it is preliminarily determined that it is likely to be an ancient coin of Kaiyuan Tongbao of the Tang Dynasty. The server also performs GRU-based feature interaction on the multi-dimensional feature set of the ancient coin sub-image. Taking the multi-dimensional feature set of the sub-image of the character area as an example, the GRU deeply analyzes the relationships between the detailed features of the characters. It considers the mutual influence between features such as the stroke trend and edge clarity of the characters, and extracts more detailed feature information through continuous feature interaction. After processing by the GRU, the server obtains the fine-grained image features of the ancient coin sub-image. These fine-grained image features can accurately describe the subtle differences of the characters, such as the starting angle of the character “Kai” and the length of the second horizontal stroke of the character “Yuan”, and the detailed information is of great significance for accurately determining the edition of the ancient coin. Through the above steps, the server completes the feature extraction processing on the ancient coin training image and its various ancient coin sub-images, and obtains the coarse-grained image features and fine-grained image features, providing rich and accurate feature data for subsequent ancient coin type identification and model training.

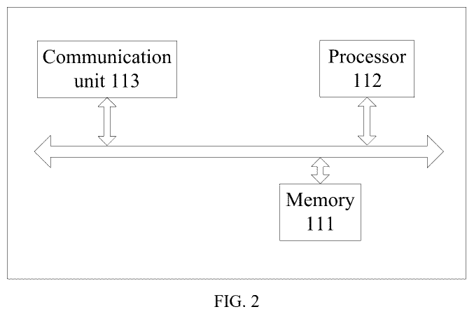

An embodiment of the present disclosure provides computer device 100. The computer device 100 includes a processor and a non-volatile memory storing a computer instruction. When the computer instruction is executed by the processor, the computer device 100 implements the aforementioned method for fine identification of types of ancient coins based on AI architecture optimization. As shown in FIG. 2, FIG. 2 is a schematic block diagram of the computer device 100 provided by an embodiment of the present disclosure. The computer device 100 includes memory 111, processor 112, and communication unit 113. To achieve data transmission or interaction, the memory 111, the processor 112, and the communication unit 113 are electrically connected to each other directly or indirectly. For example, these elements can be electrically connected to each other through one or more communication buses or signal lines.

For the purpose of illustration, the foregoing description has been made with reference to specific embodiments. However, the illustrative discussions above are not intended to be exhaustive or to limit the present disclosure to the precise forms disclosed. Numerous modifications and variations are possible in light of the above teachings. The embodiments are chosen and described in order to best explain the principles of the present disclosure and its practical application, thereby enabling those skilled in the art to make the best use of the present disclosure and various embodiments with different modifications as are suited to the particular use contemplated.

1. A method for fine identification of types of ancient coins based on artificial intelligence (AI) architecture optimization, comprising:
acquiring, by a multispectral imaging device, original ancient coin image data, performing illumination equalization processing and noise filtering on the original ancient coin image data, and generating a standardized initial ancient coin image;
performing enhancement processing on the initial ancient coin image, and generating a target ancient coin image, wherein the enhancement processing comprises texture enhancement processing based on an edge-preserving algorithm;
invoking a pre-trained target ancient coin identification model to perform ancient coin type identification on the target ancient coin image, and obtaining an ancient coin type identifier of the target ancient coin image; and
triggering directional retrieval from a preset historical ancient coin database based on the ancient coin type identifier, outputting ancient coin-related data corresponding to the ancient coin type identifier, and generating a fine identification report of an ancient coin type based on the ancient coin-related data;
wherein the target ancient coin identification model is obtained through training by following steps:
acquiring an ancient coin identification model and a sample ancient coin image, wherein ancient coin training images of the sample ancient coin image comprise a first ancient coin training image and second ancient coin training images; and the first ancient coin training image is labeled with a corresponding ancient coin type identifier, and the second ancient coin training images are unlabeled ancient coin training images;
for each of the ancient coin training images, performing region division processing on the ancient coin training image, and acquiring a plurality of ancient coin sub-images of the ancient coin training image;
performing, by the ancient coin identification model, feature extraction processing on the ancient coin training image and each of the ancient coin sub-images of the ancient coin training image, and obtaining a coarse-grained image feature of the ancient coin training image and a fine-grained image feature of each of the ancient coin sub-images;
performing contrastive learning on the coarse-grained image feature of each of the ancient coin training images of the sample ancient coin image according to the ancient coin type identifier of the first ancient coin training image, and obtaining an ancient coin type identifier of the second ancient coin training images;
constructing a coarse-grained feature set according to the coarse-grained image feature of each of the ancient coin training images, and constructing a fine-grained feature set according to the fine-grained image feature of the ancient coin sub-image of each of the ancient coin training images;
for each of the ancient coin training images, traversing at least one neighboring coarse-grained image feature neighboring the coarse-grained image feature of the ancient coin training image in the coarse-grained feature set, and determining a category candidate of the ancient coin training image according to an ancient coin type identifier of the ancient coin training image to which the neighboring coarse-grained image feature belongs;
for each of the ancient coin sub-images of the ancient coin training image, traversing at least one neighboring fine-grained image feature neighboring the fine-grained image feature of the ancient coin sub-image in the fine-grained feature set, and determining a category candidate of the ancient coin sub-image according to the ancient coin type identifier of the ancient coin training image to which the neighboring fine-grained image feature belongs;
performing probability distribution modeling on the ancient coin type identifier of the category candidate of the ancient coin sub-image, and determining an ancient coin type confidence distribution of the ancient coin sub-image;
performing probability distribution modeling on the ancient coin type identifier of the category candidate of the ancient coin training image to which the ancient coin sub-image belongs, and determining an ancient coin type confidence distribution of the ancient coin training image to which the ancient coin sub-image belongs;
calculating a multi-granularity feature alignment metric between the ancient coin sub-image and the ancient coin training image to which the ancient coin sub-image belongs according to the ancient coin type confidence distribution of the ancient coin sub-image and the ancient coin type confidence distribution of the ancient coin training image to which the ancient coin sub-image belongs;
performing ancient coin type identification on the ancient coin training image according to the coarse-grained image feature of the ancient coin training image, and obtaining a coarse-grained type confidence distribution corresponding to the ancient coin training image;
performing ancient coin type identification on the ancient coin sub-image according to the fine-grained image feature of the ancient coin sub-image, and obtaining a fine-grained type confidence distribution corresponding to the ancient coin sub-image; and
performing iterative optimization on a parameter of the ancient coin identification model according to the coarse-grained type confidence distribution, the fine-grained type confidence distribution, the multi-granularity feature alignment metric and the ancient coin type identifier of the second ancient coin training images, and obtaining the target ancient coin identification model.

2. The method according to claim 1, wherein the performing contrastive learning on the coarse-grained image feature of each of the ancient coin training images of the sample ancient coin image according to the ancient coin type identifier of the first ancient coin training image, and obtaining the ancient coin type identifier of the second ancient coin training images comprises:
setting category cardinality-based ancient coin type templates, and calculating a feature matching degree between the coarse-grained image feature of each of the ancient coin training images of the sample ancient coin image and each of the ancient coin type templates;
for each of the ancient coin training images, determining a target ancient coin type template feature-neighboring the ancient coin training image from the ancient coin type templates according to the feature matching degree and the ancient coin type identifier of the first ancient coin training image, and adding the ancient coin training image to an ancient coin type pool corresponding to the target ancient coin type template; and for an ancient coin type pool corresponding to each of the ancient coin type templates, selecting an ancient coin training image with highest type representativeness from the ancient coin type pool as an evolved ancient coin type template;
repeating the step of calculating the feature matching degree between the coarse-grained image feature of each of the ancient coin training images of the sample ancient coin image and each of the ancient coin type templates until the determined ancient coin type template meets a feature fluctuation threshold range; and
determining, according to the ancient coin type identifier of the first ancient coin training image in a target ancient coin image set corresponding to the ancient coin type template that meets the feature fluctuation threshold range, the ancient coin type identifier of the second ancient coin training images in the target ancient coin image set.

3. The method according to claim 1, wherein the performing contrastive learning on the coarse-grained image feature of each of the ancient coin training images of the sample ancient coin image according to the ancient coin type identifier of the first ancient coin training image, and obtaining the ancient coin type identifier of the second ancient coin training images comprises:
determining a sample feature matching degree between every two ancient coin training images according to the coarse-grained image features of the every two ancient coin training images;
constructing an ancient coin association hypergraph according to the sample feature matching degree, wherein the ancient coin association hypergraph represents an association topology between the ancient coin training images; and
performing type feature propagation processing on the ancient coin type identifier of the first ancient coin training image according to the ancient coin association hypergraph, and obtaining the ancient coin type identifier of the second ancient coin training images.

4. The method according to claim 3, wherein the ancient coin association hypergraph comprises feature units corresponding to each of the ancient coin training images and a topological connection between the feature units, and the topological connection represents the association topology between every two connected feature units;
the performing type feature propagation processing on the ancient coin type identifier of the first ancient coin training image according to the ancient coin association hypergraph, and obtaining the ancient coin type identifier of the second ancient coin training images comprises:
performing type feature propagation processing on the ancient coin type identifier of the first ancient coin training image through the topological connection between the feature units in the ancient coin association hypergraph to determine a reference ancient coin type identifier of the second ancient coin training images; and
for each of the second ancient coin training images, performing predictive iterative optimization on the reference ancient coin type identifier of the second ancient coin training image according to a neighboring feature unit of the second ancient coin training image in the ancient coin association hypergraph until a result of the feature unit in the ancient coin association hypergraph is stably determined, and obtaining the ancient coin type identifier of the second ancient coin training image.

5. The method according to claim 1, wherein the performing iterative optimization on the parameter of the ancient coin identification model according to the coarse-grained type confidence distribution, the fine-grained type confidence distribution, the multi-granularity feature alignment metric and the ancient coin type identifier of the second ancient coin training images, and obtaining the target ancient coin identification model comprises:
for each of the ancient coin training images, calibrating the ancient coin type identifier of each of the ancient coin training images according to the fine-grained type confidence distribution of each of the ancient coin sub-images of the ancient coin training image and the multi-granularity feature alignment metric corresponding to each of the ancient coin sub-images, and obtaining a calibrated ancient coin type identifier of each of the ancient coin training images;
integrating the calibrated ancient coin type identifier of each of the ancient coin training images according to the coarse-grained type confidence distribution corresponding to each of the ancient coin training images, and obtaining a coarse-grained error parameter; and
performing iterative optimization on the parameter of the ancient coin identification model according to the coarse-grained error parameter, and obtaining the target ancient coin identification model.

6. The method according to claim 5, wherein the performing iterative optimization on the parameter of the ancient coin identification model according to the coarse-grained error parameter, and obtaining the target ancient coin identification model comprises:
calculating a fine-grained category error parameter of each of the ancient coin sub-images according to the fine-grained type confidence distribution of each of the ancient coin sub-images and the ancient coin type identifier of the ancient coin training image to which each of the ancient coin sub-images belongs; and
performing iterative optimization on the parameter of the ancient coin identification model according to the coarse-grained error parameter and the fine-grained category error parameter, and obtaining the target ancient coin identification model.

7. The method according to claim 6, wherein the performing iterative optimization on the parameter of the ancient coin identification model according to the coarse-grained error parameter and the fine-grained category error parameter, and obtaining the target ancient coin identification model comprises:
performing distribution difference calculation processing between the fine-grained type confidence distribution of each of the ancient coin sub-images and a reference distribution, and obtaining a feature difference metric corresponding to each of the ancient coin sub-images;
integrating the fine-grained category error parameter and the feature difference metric according to the multi-granularity feature alignment metric corresponding to each of the ancient coin sub-images, and obtaining a fine-grained error parameter of each of the ancient coin sub-images; and
performing iterative optimization on the parameter of the ancient coin identification model according to the coarse-grained error parameter and the fine-grained error parameter of each of the ancient coin sub-images of the ancient coin training image, and obtaining the target ancient coin identification model.

8. The method according to claim 1, wherein the performing, by the ancient coin identification model, feature extraction processing on the ancient coin training image and each of the ancient coin sub-images of the ancient coin training image, and obtaining the coarse-grained image feature of the ancient coin training image and the fine-grained image feature of each of the ancient coin sub-images comprises:
obtaining, for the ancient coin training image, a visual feature set in a visual feature domain and an inscription feature set in a semantic feature domain, and obtaining, for each of the ancient coin sub-images of the ancient coin training image, a visual sub-feature set in the visual feature domain and an inscription sub-feature set in the semantic feature domain;
performing cross-domain feature integration processing on the visual feature set and the inscription feature set of the ancient coin training image, and obtaining a multi-dimensional feature set of the ancient coin training image;
performing cross-domain feature integration processing on the visual sub-feature set and the inscription sub-feature set of the ancient coin sub-image, and obtaining a multi-dimensional feature set of each of the ancient coin sub-images;
performing, by the ancient coin identification model, gated recurrent unit (GRU)-based feature interaction on the multi-dimensional feature set of the ancient coin training image, and obtaining the coarse-grained image feature of the ancient coin training image; and
performing, by the ancient coin identification model, GRU-based feature interaction on the multi-dimensional feature set of each of the ancient coin sub-images, and obtaining the fine-grained image feature of each of the ancient coin sub-images.

9. A server system, comprising a server, wherein the server is configured to implement the method according to claim 1.

10. The server system according to claim 9, wherein the performing contrastive learning on the coarse-grained image feature of each of the ancient coin training images of the sample ancient coin image according to the ancient coin type identifier of the first ancient coin training image, and obtaining the ancient coin type identifier of the second ancient coin training images comprises:
setting category cardinality-based ancient coin type templates, and calculating a feature matching degree between the coarse-grained image feature of each of the ancient coin training images of the sample ancient coin image and each of the ancient coin type templates;
for each of the ancient coin training images, determining a target ancient coin type template feature-neighboring the ancient coin training image from the ancient coin type templates according to the feature matching degree and the ancient coin type identifier of the first ancient coin training image, and adding the ancient coin training image to an ancient coin type pool corresponding to the target ancient coin type template; and for an ancient coin type pool corresponding to each of the ancient coin type templates, selecting an ancient coin training image with highest type representativeness from the ancient coin type pool as an evolved ancient coin type template;
repeating the step of calculating the feature matching degree between the coarse-grained image feature of each of the ancient coin training images of the sample ancient coin image and each of the ancient coin type templates until the determined ancient coin type template meets a feature fluctuation threshold range; and
determining, according to the ancient coin type identifier of the first ancient coin training image in a target ancient coin image set corresponding to the ancient coin type template that meets the feature fluctuation threshold range, the ancient coin type identifier of the second ancient coin training images in the target ancient coin image set.

11. The server system according to claim 9, wherein the performing contrastive learning on the coarse-grained image feature of each of the ancient coin training images of the sample ancient coin image according to the ancient coin type identifier of the first ancient coin training image, and obtaining the ancient coin type identifier of the second ancient coin training images comprises:
determining a sample feature matching degree between every two ancient coin training images according to the coarse-grained image features of the every two ancient coin training images;
constructing an ancient coin association hypergraph according to the sample feature matching degree, wherein the ancient coin association hypergraph represents an association topology between the ancient coin training images; and
performing type feature propagation processing on the ancient coin type identifier of the first ancient coin training image according to the ancient coin association hypergraph, and obtaining the ancient coin type identifier of the second ancient coin training images.

12. The server system according to claim 11, wherein the ancient coin association hypergraph comprises feature units corresponding to each of the ancient coin training images and a topological connection between the feature units, and the topological connection represents the association topology between every two connected feature units;
the performing type feature propagation processing on the ancient coin type identifier of the first ancient coin training image according to the ancient coin association hypergraph, and obtaining the ancient coin type identifier of the second ancient coin training images comprises:
performing type feature propagation processing on the ancient coin type identifier of the first ancient coin training image through the topological connection between the feature units in the ancient coin association hypergraph to determine a reference ancient coin type identifier of the second ancient coin training images; and
for each of the second ancient coin training images, performing predictive iterative optimization on the reference ancient coin type identifier of the second ancient coin training image according to a neighboring feature unit of the second ancient coin training image in the ancient coin association hypergraph until a result of the feature unit in the ancient coin association hypergraph is stably determined, and obtaining the ancient coin type identifier of the second ancient coin training image.

13. The server system according to claim 9, wherein the performing iterative optimization on the parameter of the ancient coin identification model according to the coarse-grained type confidence distribution, the fine-grained type confidence distribution, the multi-granularity feature alignment metric and the ancient coin type identifier of the second ancient coin training images, and obtaining the target ancient coin identification model comprises:
for each of the ancient coin training images, calibrating the ancient coin type identifier of each of the ancient coin training images according to the fine-grained type confidence distribution of each of the ancient coin sub-images of the ancient coin training image and the multi-granularity feature alignment metric corresponding to each of the ancient coin sub-images, and obtaining a calibrated ancient coin type identifier of each of the ancient coin training images;
integrating the calibrated ancient coin type identifier of each of the ancient coin training images according to the coarse-grained type confidence distribution corresponding to each of the ancient coin training images, and obtaining a coarse-grained error parameter; and
performing iterative optimization on the parameter of the ancient coin identification model according to the coarse-grained error parameter, and obtaining the target ancient coin identification model.

14. The server system according to claim 13, wherein the performing iterative optimization on the parameter of the ancient coin identification model according to the coarse-grained error parameter, and obtaining the target ancient coin identification model comprises:
calculating a fine-grained category error parameter of each of the ancient coin sub-images according to the fine-grained type confidence distribution of each of the ancient coin sub-images and the ancient coin type identifier of the ancient coin training image to which each of the ancient coin sub-images belongs; and
performing iterative optimization on the parameter of the ancient coin identification model according to the coarse-grained error parameter and the fine-grained category error parameter, and obtaining the target ancient coin identification model.

15. The server system according to claim 14, wherein the performing iterative optimization on the parameter of the ancient coin identification model according to the coarse-grained error parameter and the fine-grained category error parameter, and obtaining the target ancient coin identification model comprises:
performing distribution difference calculation processing between the fine-grained type confidence distribution of each of the ancient coin sub-images and a reference distribution, and obtaining a feature difference metric corresponding to each of the ancient coin sub-images;
integrating the fine-grained category error parameter and the feature difference metric according to the multi-granularity feature alignment metric corresponding to each of the ancient coin sub-images, and obtaining a fine-grained error parameter of each of the ancient coin sub-images; and
performing iterative optimization on the parameter of the ancient coin identification model according to the coarse-grained error parameter and the fine-grained error parameter of each of the ancient coin sub-images of the ancient coin training image, and obtaining the target ancient coin identification model.

16. The server system according to claim 9, wherein the performing, by the ancient coin identification model, feature extraction processing on the ancient coin training image and each of the ancient coin sub-images of the ancient coin training image, and obtaining the coarse-grained image feature of the ancient coin training image and the fine-grained image feature of each of the ancient coin sub-images comprises:
obtaining, for the ancient coin training image, a visual feature set in a visual feature domain and an inscription feature set in a semantic feature domain, and obtaining, for each of the ancient coin sub-images of the ancient coin training image, a visual sub-feature set in the visual feature domain and an inscription sub-feature set in the semantic feature domain;
performing cross-domain feature integration processing on the visual feature set and the inscription feature set of the ancient coin training image, and obtaining a multi-dimensional feature set of the ancient coin training image;
performing cross-domain feature integration processing on the visual sub-feature set and the inscription sub-feature set of the ancient coin sub-image, and obtaining a multi-dimensional feature set of each of the ancient coin sub-images;
performing, by the ancient coin identification model, gated recurrent unit (GRU)-based feature interaction on the multi-dimensional feature set of the ancient coin training image, and obtaining the coarse-grained image feature of the ancient coin training image; and
performing, by the ancient coin identification model, GRU-based feature interaction on the multi-dimensional feature set of each of the ancient coin sub-images, and obtaining the fine-grained image feature of each of the ancient coin sub-images.
